(19) United States
(12) Patent Application Publication
(10) Pub. No.: US 2026/0349870 A1
(43) Pub. Date: Nov. 5, 2026

(54) LOW LATENCY CYCLIC REDUNDANCY CODE SYSTEM

(71) Applicant: Micron Technology, Inc., Boise, ID (US)

(72) Inventors: Sivagnanam Parthasarathy, Carlsbad, CA (US); Revanth Gadi, Hyderabad (IN); Chandrakanth Rapalli, Hyderabad (IN)

(21) Appl. No.: 19/197,366

(22) Filed: May 2, 2025

(51) Int. Cl. G06F 11/10

(52) U.S. Cl. CPC G06F 11/1004

(57) ABSTRACT

This disclosure is directed to a system for performing error detection and correction. The system generates a cyclic redundancy check (CRC) estimate based on received data symbols in parallel with decoding the received data symbols. The system retrieves, based on information generated in response to decoding the received data symbols, CRC adjustment data from a plurality of predetermined CRC adjustment sets. The system applies the CRC adjustment data to the CRC estimate to detect one or more errors in decoding the received data symbols.

### TECHNICAL FIELD

Examples of the disclosure relate generally to data communication systems and, more specifically, to performing cyclic redundancy check (CRC) operations for detecting decoding errors.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 illustrates a CRC system, in accordance with some examples.

FIG. 3 illustrates residual value matrices, in accordance with some examples.

FIG. 4 illustrates a diagram of operations performed using a CRC component, in accordance with some examples.

FIG. 5 illustrates a diagram of operations performed using a CRC component, in accordance with some examples.

FIG. 6 is a block diagram of an example computer system, according to some examples.

### DETAILED DESCRIPTION

The present disclosure is directed to a system including a memory device and a processing device, operatively coupled to the memory device, programmed to perform operations that improve data transmission reliability through parallel CRC processing. The system does this by generating CRC estimates in parallel with error correction decoding and applying precise CRC adjustments based on identified errors. Specifically, the disclosed processing device generates CRC estimates using a state-space model that processes multiple noisy received data symbols in parallel (simultaneously) while error correction decoding of the noisy received data symbols is ongoing. When error locations and magnitudes are identified by the error correction operations (e.g., through Reed-Solomon decoding), the disclosed system retrieves error detection/correction information from a pre-computed adjustment matrix corresponding to the error locations and magnitudes. By using the error detection/correction information obtained from the pre-computed adjustment matrix in combination with the initial CRC estimates, the disclosed system can detect errors in performing the error correction decoding. This approach enhances system performance by enabling early transmission of acknowledgment signals without waiting for complete decode processing. The pre-computed adjustment matrices can include remainder values corresponding to different error magnitudes, allowing the system to efficiently validate error correction results through simple exclusive-OR operations. This can significantly improve overall system performance and reliability by reducing buffer requirements and preventing back pressure on host transmission while maintaining robust error detection through parallel CRC processing and adjustment.

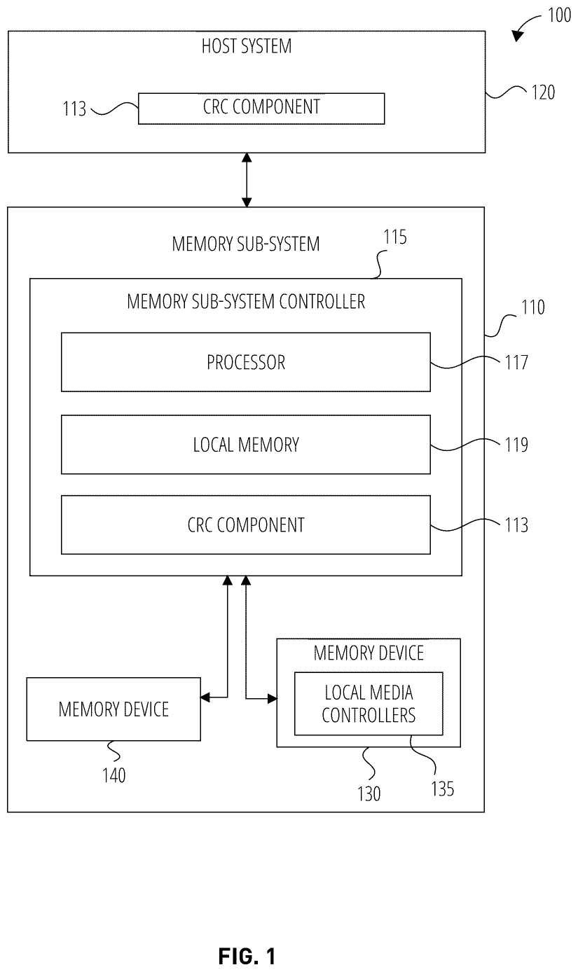

A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command, erase command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of garbage collection (GC) management operations. The data that is re-written, for example as initiated by the firmware, is hereinafter referred to as “GC data.” Examples of system data include, but are not limited to, system tables (e.g., logical-to-physical memory address mapping table, also referred to herein as a logical-to-physical (L2P) mapping table (referred to as a L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package. The memory device can be divided into one or more zones where each zone is associated with a different set of host data or user data or application.

CRC is a fundamental error detection mechanism used in data transmission systems. In its basic form, CRC works by treating data as coefficients of a polynomial and performing polynomial division using a predetermined generator polynomial. The remainder from this division becomes the CRC value that is appended to the transmitted data. In conventional systems, particularly for high-speed interfaces like UniPro 3.0 (e.g., interfacing between a host system and a memory controller), CRC operations are performed sequentially after error correction decoding is complete. UniPro (or Unified Protocol) is a high-speed interface technology for interconnecting integrated circuits in mobile and mobile-influenced electronics. This conventional approach processes data through a Linear Feedback Shift Register (LFSR) implementation, where the CRC check cannot begin until the entire codeword has been corrected by the decoder. The UniPro protocol implements a layered architecture based on the OSI model, with specific adaptations for high-speed data transmission in storage applications. The protocol stack consists of multiple layers, each handling distinct aspects of data communication. At the lowest level, Layer 1 (Physical Layer) handles the fundamental signal transmission using PAM-4 modulation for high-speed data transfer over the physical channel. Layer 1.5 serves as a PHY adapter layer, providing abstraction from the physical layer implementation and supporting the transmission of UniPro symbols. This layer interfaces with the Reed-Solomon (RS) encoding and decoding operations that provide error correction capabilities for up to 3 symbol errors. Layer 2 (Data Link Layer) manages frame-level reliability and includes the CRC computation and verification mechanisms. The higher layers (3 and 4) handle network routing and transport functions respectively, with Layer 4 implementing flow control mechanisms. The Device Management Entity (DME) coordinates across layers, while the Application Layer (LA) remains protocol-independent to support different use cases.

This sequential processing creates significant inefficiencies in several ways. First, it introduces substantial latency since the system needs to wait for complete Reed-Solomon decoding before beginning CRC verification. This delay is particularly problematic in modern high-speed interfaces that process multiple symbols simultaneously, as the traditional LFSR approach processes only one symbol at a time. The increased latency can force transmitters (e.g., the host system, or CPU) to maintain larger buffer sizes to accommodate delayed acknowledgments (e.g., from the memory controller), which can take up to 16 KB of buffer space. Furthermore, conventional approaches create system bottlenecks in the transmission protocol. When using smaller buffers on the transmitter side, the delayed CRC verification can cause back pressure on host transmission, effectively reducing overall system throughput. This becomes especially problematic when working with host systems that have limited buffer capabilities, as the delayed acknowledgment signals can prevent efficient use of the available bandwidth.

The conventional sequential processing also fails to take advantage of modern parallel processing capabilities. With UniPro 3.0 supporting high-speed interfaces using pulse amplitude modulation (PAM4) encoding, the ability to process multiple symbols simultaneously becomes important for maintaining system performance. However, conventional CRC implementations remain tied to serial processing models, creating a mismatch between transmission capabilities and error detection processing. Additionally, the conventional approach requires maintaining larger replay buffers for retransmission purposes. Since acknowledgment signals cannot be sent until both decoding and CRC verification are complete, transmitters may need to store larger amounts of data (up to 16 KB) while waiting for verification. This increased buffer requirement adds to system complexity and resource utilization, particularly when operating with constrained buffer sizes of 8 KB or 10 KB.

The present disclosure addresses inefficiencies in conventional CRC processing by implementing a novel parallel architecture that reduces system latency and buffer requirements. The system utilizes a state-space model to generate CRC estimates simultaneously with Reed-Solomon error correction decoding and can process up to 32 symbols per cycle. The disclosed system computes an estimated CRC based on the noisy non-decoded received data symbols. An efficient state-space implementation maintains a state vector r(t) representing remainder values. The disclosed system processes multiple received symbols (e.g., noisy symbols that have not been processed by the decoding engine, such as the Reed-Solomon decoder) in parallel by applying pre-computed matrices to the current state vector and input symbols respectively, generating updated remainder values. To enable rapid CRC validation, the disclosed system maintains a comprehensive set of pre-computed adjustment matrices. When the Reed-Solomon decoder identifies error locations and magnitudes, the disclosed system retrieves the corresponding adjustment matrices and selects specific sets of rows based on the binary decomposition of the error magnitudes. The selected sets of rows undergo exclusive-OR operations to generate partial CRC adjustments for each error location, which are then combined with the CRC estimate to produce a final adjusted CRC value. Based on the final adjusted CRC value, the disclosed system can detect errors in the decoding of the received data symbols. In some cases, the layer 2 of the UniPro interface can implement the state-space model for CRC processing that enables parallel computation of CRC estimates on 32 symbols per cycle, along with the CRC adjustment mechanism using pre-computed lookup tables.

This parallel processing architecture enables early transmission of acknowledgment signals without waiting for complete decode processing. The disclosed system can validate data integrity and initiate acknowledgments while decoding is still in progress, reducing transmitter buffer requirements from 16 KB to as low as 8 KB or 10 KB. For systems with smaller buffers, this early acknowledgment capability prevents back pressure on host transmission and maintains efficient throughput. The implementation can operate within the UniPro 3.0 protocol framework, supporting high-speed interfaces that utilize pulse amplitude modulation (PAM4) encoding. The system can process received data symbols at a rate of 32 symbols per cycle while generating CRC estimates in parallel with syndrome computation, ensuring robust error detection without introducing additional latency.

In some examples, a system includes a memory device and processing device that work together to perform CRC operations on received data symbols. The system generates CRC estimates in parallel while decoding the received data symbols, enabling fast error detection while decoding of received data. The system employs a state-space model to process multiple data symbols in parallel, specifically operating at a rate of 32 symbols per cycle to generate corresponding remainder values. This parallel processing approach improves efficiency compared to processing one symbol at a time.

In certain implementations, the processing device uses a Reed-Solomon decoder to process the received data symbols while simultaneously generating CRC estimates using the state-space model. The Reed-Solomon decoder provides information about error magnitudes and locations in the received data symbols, which can be used to retrieve appropriate CRC adjustment data from predetermined sets. The processing device maintains predetermined CRC adjustment sets stored as matrices of remainder values. For each symbol position, an adjustment matrix is generated with rows corresponding to error magnitudes represented as powers of 2. These remainder values are computed by evaluating R_{g(x)}[x⁸a(x)] using a generator polynomial of degree 8 in the Galois Field GF(2⁸). The adjustment matrices can, for example, enable reconstruction of CRC adjustments for any error magnitude between 0 and 255 by selecting and combining rows that correspond to the binary decomposition of the error magnitude.

In some cases, the processing device performs error detection by selecting a specific matrix corresponding to the error location provided by the Reed-Solomon decoder and retrieving rows matching the error magnitude. The processing device then performs exclusive-OR operations on the retrieved values to generate partial CRC adjustments, which can be compared with the CRC estimate to detect decoding errors. The processing device can determine whether to transmit acknowledgment or negative acknowledgment signals based on the CRC estimates before processing all received data symbols in a buffer. This early detection capability helps reduce buffer requirements and improves system efficiency by enabling faster response times. The processing device processes received data symbols at 32 symbols per cycle, generating CRC estimates in parallel with syndrome computation, allowing for quick transmission of acknowledgment signals before completing full decode processing.

The implementation can be realized through various forms, including as instructions stored on non-transitory machine-readable storage media or as a method performing the described operations. In all cases, the core functionality remains focused on parallel CRC estimation and adjustment for efficient error detection.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, a UniPro 3.0 interface (or other UniPro interface), and so forth. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a 3D cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single level cells (SLCs), can store one bit per cell. Other types of memory cells, such as multi-level cells (MLCs), tri-level cells (TLCs), quad-level cells (QLCs), and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or BSs. As used herein, a block including SLCs can be referred to as a SLC block, a block including MLCs can be referred to as a MLC block, a block including TLCs can be referred to as a TLC block, and a block including QLCs can be Referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative- or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data (e.g., performing GC operations) at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), and so forth), or other suitable processor.

The memory sub-system controller 115 can include a processor (processing device) 117 configured (or programmed) to execute instructions stored in local memory 119. In the illustrated example, the local memory 119 of the memory sub-system controller 115 includes an embedded memory configured (or programmed) to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, error detection and ECC operations (including CRC operations), encryption operations, caching operations, and address translations between a logical address (e.g., LBA, namespace) and a physical memory address (e.g., physical block address in a physical address space of the memory device 130 or memory device 140) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (mNAND) device. Any operation discussed as being performed by the memory sub-system controller 115 can be similarly performed by the local media controllers 135 and vice versa.

The memory sub-system controller 115 includes a CRC component 113 that implements an efficient, low-latency CRC solution for handling error detection in high-speed data transmission over, interfaces, such as the UniPro 3.0 interface between the memory sub-system controller 115 and the host system 120. The CRC component 113 processes data symbols in parallel using a state-space model that enables computation of CRC estimates on 32 symbols per cycle, which can reduce processing latency compared to traditional sequential approaches. The CRC component 113 works in conjunction with the RS decoder to enable early error detection in the noisy un-decoded data symbols without waiting for complete decode completion. When potential errors are detected in the received data stream, the CRC component 113 utilizes pre-computed lookup tables (e.g., 241×8×8 matrices) to quickly adjust the CRC estimate based on error locations and magnitudes provided by the RS decoder. This parallel processing approach enables early generation of ACK/NACK signals, reducing buffer requirements and improving overall system throughput. The reduced latency is particularly beneficial for systems with smaller layer 2 (L2) buffers on the transmitter side, as it helps prevent back pressure issues that could impact transmission performance.

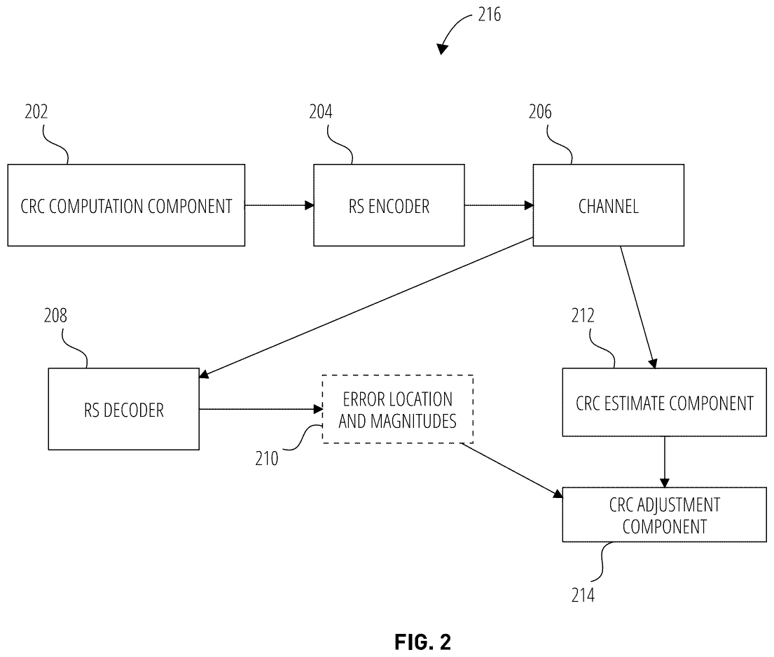

FIG. 2 illustrates a CRC system 216, in accordance with some examples. The CRC system 216 can include implementations of the CRC component 113 in the transmitter and/or the receiver. The CRC system 216 implements parallel CRC processing with early error detection capabilities. The CRC system 216 includes several components that work together to enable efficient error detection. The CRC system 216 can include a CRC computation component 202, a RS encoder 204, a channel 206, a RS decoder 208, a CRC estimate component 212, and/or a CRC adjustment component 214. While the disclosed techniques are discussed with respect to a host system 120 (as the transmitter) communicating with a memory sub-system 110 (as the receiver), similar techniques can be applied to any other system that has a transmitter communicating with a receiver over a noisy channel and using RS coding techniques.

In some examples, the CRC computation component 202 (e.g., implemented by the host system 120) can receive input data (e.g., from an application running on the host system 120) and can generate CRC symbols using a state-space model that can process multiple symbols in parallel. The CRC computation component 202 can implement the initial CRC computation on the transmitter side before data transmission.

The CRC computation according to the state-space model can begin with a message polynomial a(x) where the coefficients ai are elements in the Galois Field GF(2⁸), defined by the primitive polynomial p(x)=x⁸+x⁵+x³+1. The Galois Field GF(2⁸) is a finite field used for CRC computations in this system that consists of 256 elements (2⁸=256). In this field, each element can be represented as an 8-bit symbol, allowing values from 0 to 255. The field supports basic arithmetic operations (addition, multiplication, etc.) that follow specific mathematical properties defined by the primitive polynomial. For the CRC system, GF(2⁸) enables efficient computation of remainders and error detection because each symbol in the message polynomial a(x) is an element of GF(2⁸), the generator polynomial g(x) coefficients (α¹ through α⁸) are elements of GF(2⁸), and the remainder values in the adjustment matrices (discussed below) are computed in GF(2⁸).

The generator polynomial g(x) used for CRC computation is can be defined as g(x)=(x+α¹)(x+α²)(x+α³)(x+α⁴)(x+α⁵)(x+α⁶)(x+α⁷)(x+α⁸)=x⁸+α¹⁷²x⁷+α¹¹⁶x⁶+α¹⁸⁶x⁵+α¹⁷²x⁴+α¹⁹⁵x³+α¹³⁴x²+α¹⁹⁹x¹+α³⁶x⁰. The CRC computation evaluates the expression: R_{g(x)}(x⁸u(x)) which refers to [(x⁸u(x)) % g(x)]. The variable u (x) refers to the user data and may be optionally referred to as m (x) as a message. The state-space model for processing one symbol at a time is given by: r(t+1)=Ar(t)+bu (t) where A is a matrix composed of the generator polynomial coefficients, an identity matrix, and a zero vector, as shown below:

$$r ( t + 1 ) = Ar ( t ) + bu ( t ) where A = [ \begin{matrix}b & \begin{matrix}I \\ 0\end{matrix} ] and b = [ \begin{matrix}{g}_{N - K - 1} \\ {g}_{N - K - 2} \\ … \\ {g}_{0}\end{matrix} ]\end{matrix}$$

For parallel processing of w symbols (where w=32), the equation expands to: r(t+w)=A^{w}r(t)+A^{w-1}bu(t)+ . . . +Abu(t+w−2)+bu(t+w−1)=A^{w}r(t)+[A^{w-1}b . . . Abb][u(t)u(t+1) . . . u(t+w−1)]^{T}. For example, when processing 241 data symbols with w=32, the input data can be divided into 8 processing steps (8*32=256 symbols). For each step, 32 symbols can be processed in parallel using the state-space equation. The matrices A^{w} and [A^{w-1}b . . . Abb] can be pre-computed based on the generator polynomial. The result generates 8 CRC symbols that are appended to the original 241 data symbols, producing 249 symbols for RS encoding.

The state-space implementation maintains a state vector r(t) representing remainder values. The system processes multiple received symbols in parallel by applying pre-computed matrices to the current state vector and input symbols respectively, generating updated remainder values. This parallel processing approach using the state-space model enables processing of 32 symbols per cycle, which can improve efficiency compared to traditional sequential LFSR-based approaches that process only one symbol at a time. The pre-computed matrices A and b contain the generator polynomial coefficients arranged to enable parallel processing. These matrices are used to update the state vector r(t) which contains the intermediate and final CRC values.

In some examples, starting with a 241-symbol message payload, the CRC system 216 processes 32 symbols per cycle over 8 cycles (8*32=256 symbols, with padding). For each cycle: the initial State (t=0), the state vector r(0) contains 8 remainder values initialized to zero, the first 32 symbols of message u(0) to u(31) are input. At the first cycle (t=1): the CRC computation component 202 applies the equation: r(t+w)=A^{w}r(t)+[A^{w-1}b . . . Abb][u(t)u(t+1) . . . u(t+w−1)]^{T}, where w=32, A is the pre-computed generator matrix, and b contains generator polynomial coefficients and generates a first intermediate remainder r(1). At a second cycle (t=2), the CRC computation component 202 processes the next 32 symbols u(32) to u(63) and uses the previous remainder r(1) as initial state to generate a next intermediate remainder r(2). The CRC computation component 202 continues for 8 cycles total where at each cycle the CRC computation component 202 processes 32 symbols in parallel until a final cycle generates the 8 CRC symbols as remainder r(8). For error detection (as discussed below), when errors occur, if error magnitude is 9 (binary 1001), the CRC estimate component 212 selects rows corresponding to 2³ (e.g., representing the value 8) and 2° (e.g., representing the value 1) (combined to form a magnitude of 9) from a lookup table, applies an XOR operation on these rows to generate a partial CRC adjustment and applies the adjustment to the CRC estimate to detect decoding errors.

The RS encoder 204 receives the input data and the initial CRC computation from the CRC computation component 202 and can add redundancy symbols to the data for error correction purposes. Specifically, the RS encoder 204 adds 6 redundancy symbols using RS encoding and decoding to enable correction of up to 3 symbol errors. The channel 206 represents the transmission medium through which the encoded data is sent using PAM-4 modulation. This high-speed interface can experience noise and transmission errors that need to be detected and corrected. In some cases, the channel 206 represents an interface between the memory sub-system 110 and the CPU or processing unit or processor of the host system 120.

The RS decoder 208 processes the received data to identify and correct errors using the RS technique and the redundancy symbols added by the RS encoder 204. The RS decoder 208 computes syndromes and determines both the locations and magnitudes of any errors present in the received data and outputs these values as the error location and magnitudes 210. This information is used for adjusting the CRC estimate computed by the CRC estimate component 212.

The CRC estimate component 212 operates in parallel with the RS decoder 208, calculating estimated CRC values on the noisy received data before complete decode processing is performed by the RS decoder 208. This parallel processing approach helps reduce overall system latency. The CRC adjustment component 214 provides the estimated CRC values to the CRC adjustment component 214 which uses pre-computed lookup tables (e.g., residual value matrices 322 discussed below) to adjust the CRC estimate based on the error location and magnitudes 210 identified by the RS decoder 208. This CRC adjustment component 214 enables quick CRC adjustments without requiring complete re-computation of the CRC. The CRC estimate component 212 performs similar operations as the CRC computation component 202 to generate a CRC estimate based on received values.

For example, the CRC estimate component 212 processes incoming noisy data using the following state-space model approach. The CRC estimate component 212 performs initial processing where the CRC estimate component 212 receives noisy data symbols before RS decoding is complete and uses the state-space model to process 32 symbols per cycle in parallel. The CRC estimate component 212 can maintain a state vector r(t) representing remainder values computed at each cycle. The CRC estimate component 212 provides or uses the state-space model by applying the equation: r(t+w)=A^{w}r(t)+[A^{w-1}b . . . Abb][u(t)u(t+1) . . . u(t+w−1)]^{T}, where w=32 for parallel processing of 32 symbols. The CRC estimate component 212 performs matrix operations where the CRC estimate component 212 uses pre-computed matrices A and b containing generator polynomial coefficients. Matrix A includes the Identity matrix and generator polynomial terms and matrix b contains coefficients for parallel symbol processing. Before adjustment, a remainder value of zero may indicate no errors in the received symbols, while a non-zero remainder indicates potential errors that require further verification through the CRC adjustment process.

In some cases, when this initial remainder value computed by the CRC estimate component 212 is zero before any adjustment, the CRC estimate component 212 may determine that no errors were detected in the received symbols. The CRC estimate component 212 (or other component) may, in response, immediately send an ACK signal to the transmitter without waiting for RS decode completion or CRC adjustment. However, if the initial remainder is non-zero, the CRC estimate component 212 may wait for the RS decoder 208 to identify error locations and magnitudes before performing CRC adjustment and making a final ACK/NACK decision. This early detection capability based on the initial remainder value helps reduce system latency and buffer requirements by enabling quick acknowledgment when no errors are present.

ACK (acknowledgment) and NACK (negative acknowledgment) are control signals used in the data transmission protocol. An ACK signal is sent by the receiver to indicate successful receipt and validation of transmitted data. The CRC system 216 sends an early ACK when no errors are detected in the CRC estimate, allowing the transmitter to free up its buffer space and continue sending new data. A NACK signal is sent when errors are detected, requesting retransmission of the data. This occurs when the CRC check indicates errors in the decoded data, requiring the transmitter to resend the affected data. These signals are used for managing buffer requirements and system throughput. Early ACK generation through parallel CRC processing allows reduction of transmitter buffer sizes from 16 KB to as low as 8 KB or 10 KB by enabling faster buffer clearing. The quick ACK/NACK response prevents back pressure on the transmitter side that could otherwise impact transmission performance.

As an example, the CRC estimate component 212 can receive 241 input symbols and can divide processing into 8 steps (8*32=256 symbols). Each step processes 32 symbols simultaneously and updates the remainder vector r(t) after each step. The CRC estimate component 212 can process the received symbols while the RS decoder identifies errors. The CRC estimate component 212 generates a CRC estimate before complete decode processing which enables early error detection.

The parallel architecture shown in CRC system 216 represents an improvement over traditional sequential CRC processing approaches. By generating CRC estimates simultaneously with RS decoding and implementing efficient adjustment mechanisms, the CRC system 216 can detect errors earlier and reduce buffer requirements. This architecture enables early transmission of acknowledgment signals without waiting for complete decode processing. The CRC system 216 can validate data integrity and initiate acknowledgments while decoding is still in progress, reducing transmitter buffer requirements from 16 KB to as low as 8 KB or 10 KB.

The CRC system shown in CRC system 216 can operate within the UniPro 3.0 protocol framework, supporting high-speed interfaces that utilize PAM-4 encoding. The parallel processing of 32 symbols per cycle, combined with the pre-computed lookup tables for CRC adjustment, ensures robust error detection without introducing additional latency.

The interaction between components enables efficient handling of both error-free transmissions and cases requiring error correction. When no errors are detected, the parallel processing allows for quick validation and acknowledgment. When errors are found, the pre-computed adjustment matrices enable rapid CRC updates based on the RS decoder's findings. The system's ability to process multiple symbols simultaneously while maintaining accuracy is enabled by the state-space model implementation in both the CRC computation and estimation components. This mathematical framework allows for efficient parallel processing while ensuring reliable error detection.

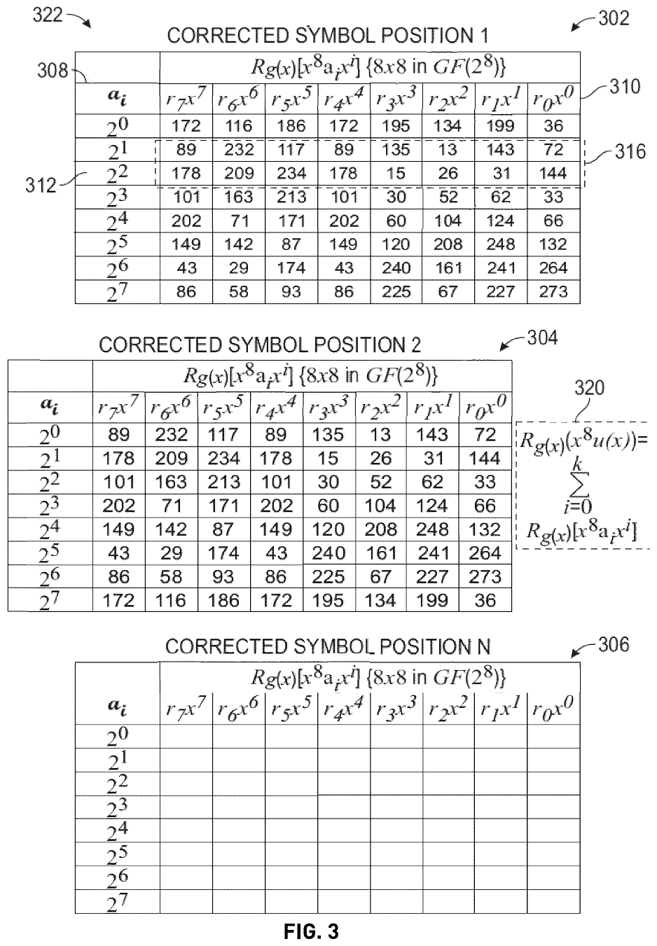

FIG. 3 illustrates residual value matrices 322, in accordance with some examples. Specifically, the RS decoder 208 can complete decoding and correcting errors in the noisy received symbols and can provide the error location and magnitudes 210 to the CRC adjustment component 214. The CRC adjustment component 214 can also receive the initial or estimated CRC from the CRC estimate component 212. The CRC adjustment component 214 can store the residual value matrices 322 and use these residual value matrices 322 to detect/correct errors that may have been introduced by the RS decoder 208.

The CRC adjustment component 214 can store multiple residual value matrices 322, one for each symbol position in the received data. A subset of these residual value matrices 322 are shown as first matrix 302 (corresponding to the corrected symbol position 1), second matrix 304 (corresponding to the corrected symbol position 2), and third matrix 306 (corresponding to the corrected symbol position N). The CRC adjustment component 214 can generate and store these residual value matrices 322 using the matrix value formula 320. The residual value matrices 322 include error magnitude values 308 associated with respective residual values.

For example, for symbol position 1, the CRC adjustment component 214 computes remainder values using the formula R_{g(x)}(x⁸u(x))=Σ(k,i=0) R_{g(x)}[x⁸aⱼxⁱ], where: the rows (aᵢ values) represent powers of 2 from 2⁰ to 2⁷, allowing representation of any error magnitude from 0-255 and the columns (r₇x⁷ through r₀x⁰) represent the 8 remainder coefficients computed in GF(2⁸). Namely, to compute a specific remainder value in first matrix 302, for error magnitude 9 (which can be represented as binary “1001”), the CRC adjustment component 214 can select row 2³ (value 8) and row 2⁰ (value 1) and can compute the remainder using generator polynomial g(x)=x⁸+α¹⁷²x⁷+α¹¹⁶x⁶+α¹⁸⁶x⁵+α¹⁷²x^{4+@195}x³+α¹³⁴x^{2+@199}x¹⁺³⁶x⁰. The CRC adjustment component 214 can then store the resulting 8 remainder coefficients in the corresponding rows. The first matrix 302 stores these pre-computed remainder values for quick lookup during CRC adjustment, enabling efficient error detection without requiring complete CRC re-computation. The process repeats for each possible error magnitude (represented as powers of 2) at symbol position 1, populating the full 8×8 matrix.

The residual values 310 are organized in columns representing different polynomial terms (r₇x⁷ through r₀x⁰), forming an 8×8 matrix in the Galois Field GF(2⁸). For each symbol position, an individual error magnitude value 312 corresponds to a set of residual values 316 that are used to adjust the CRC estimate. The matrix value formula 320 shows how the system combines multiple residual values to compute the final CRC adjustment.

Specifically, the CRC adjustment component 214 can compute a first row corresponding to 2⁰ in the first matrix 302 using the generator polynomial g(x)=x\hat{ }8+@172x\hat{ }7+@116x\hat{ }6+186x\hat{ }5+172x\hat{ }4+195x\hat{ }3+134x\hat{ }2+199x\hat{ }1+36x\hat{ }0 and applying Galois Field GF (2\hat{ }8) operations. Each row represents the remainder values when evaluating R_{g(x)}[x\hat{ }8a(x)] for increasing powers of 2 (2\hat{ }0 through 2\hat{ }7). The first row matches the generator polynomial coefficients, and subsequent rows are computed through successive Galois Field multiplications and additions according to the state-space model equations. The CRC adjustment component 214 can compute the first row corresponding to 2° in the second matrix 304 using the generator polynomial g(x)=x\hat{ }8+172x\hat{ }7+116x\hat{ }6+186x\hat{ }5+172x\hat{ }4+195x\hat{ }3+134x\hat{ }2+199x\hat{ }1+36x\hat{ }0. The values are shifted compared to the first position table to account for the different symbol position in the polynomial, while maintaining the same mathematical properties in the Galois Field GF (2\hat{ }8) operations.

In some cases, the difference in values between the first entries (172 for position 1 and magnitude of 2° and 89 for position 2 and magnitude of 2°) of the first matrix 302 and the second matrix 304 is due to how the remainder is calculated based on the symbol position in the polynomial. For position 1 (first entry=172), the CRC adjustment component 214 can evaluate R_{g(x)}[x\hat{ }8*a(x)] where a(x) has a value of 2\hat{ }0=1 at position 1. The generator polynomial g(x)=x\hat{ }8+172x\hat{ }7+116x\hat{ }6+186x\hat{ }5+172x\hat{ }4+195x\hat{ }3+134x\hat{ }2+199x\hat{ }1+36x\hat{ }0 is evaluated at position 1. The coefficient of x\hat{ }7 (172) becomes the first remainder value that is stored in the corresponding entry of the first matrix 302.

For Position 2 (first entry=89), the CRC adjustment component 214 can evaluate the same remainder function but with a(x) having a value of 2\hat{ }0=1 at position 2. This shifts the polynomial by one position, causing the remainder values to rotate. The value 89 comes from performing Galois Field GF (2\hat{ }8) operations on the generator polynomial coefficients shifted by one position. Specifically, 89=(172*x+116) mod g(x) in GF (2\hat{ }8), where x represents the shift by one position. The difference between 172 and 89 reflects how the remainder calculation changes based on the symbol position in the polynomial, with each subsequent position requiring an additional polynomial multiplication and modulo operation in the Galois Field.

When the RS decoder 208 identifies an error, the CRC adjustment component 214 selects the appropriate matrix based on the error location of the error location and magnitudes 210 provided by the RS decoder 208 and retrieves rows corresponding to the binary decomposition of the error magnitude. For example, if an error magnitude is 9 (binary “1001”), the CRC adjustment component 214 selects rows corresponding to 2³ and 2⁰, performing exclusive-OR operations on their residual values to generate the adjustment. For example, if an error magnitude is 4 (binary “0010”), the CRC adjustment component 214 selects the individual error magnitude value 312 corresponding to 2² performing exclusive-OR operations on their residual values to generate the adjustment.

The adjustment process uses these pre-computed matrices to avoid full CRC re-computation, significantly reducing processing latency. Each matrix position (302, 304, 306) contains remainder values computed by evaluating R_{g(x)}[x⁸a(x)] using the generator polynomial of degree 8 in GF(2⁸). The CRC system 216 maintains 241 such matrices, one for each possible symbol position in the input data. The residual values enable reconstruction of CRC adjustments for any error magnitude through selection and combination of appropriate matrix rows.

In some cases, to detect decoding errors, the CRC estimate component 212 performs exclusive-OR operations between the remainder computed from the noisy received data and the values obtained from the lookup tables. When the RS decoder 208 identifies error location and magnitudes 210, the CRC adjustment component 214 retrieves the corresponding rows from the residual value matrices 322. The selected rows from the lookup tables undergo exclusive-OR operations to generate partial CRC adjustments for each error location. These partial adjustments are then combined with the CRC estimate computed by the CRC estimate component 212 through additional exclusive-OR operations to produce a final adjusted CRC value.

In response to the CRC estimate component 212 determining that the final exclusive-OR result is zero, indicating no errors were detected in the decoded data, the CRC estimate component 212 sends an ACK signal to the transmitter. In response to the CRC estimate component 212 determining the exclusive-OR result is non-zero, indicating errors in the decoded data, the CRC estimate component 212 sends a NACK signal requesting retransmission. This quick error detection and response mechanism helps prevent back pressure on the transmitter side while maintaining robust error detection capabilities.

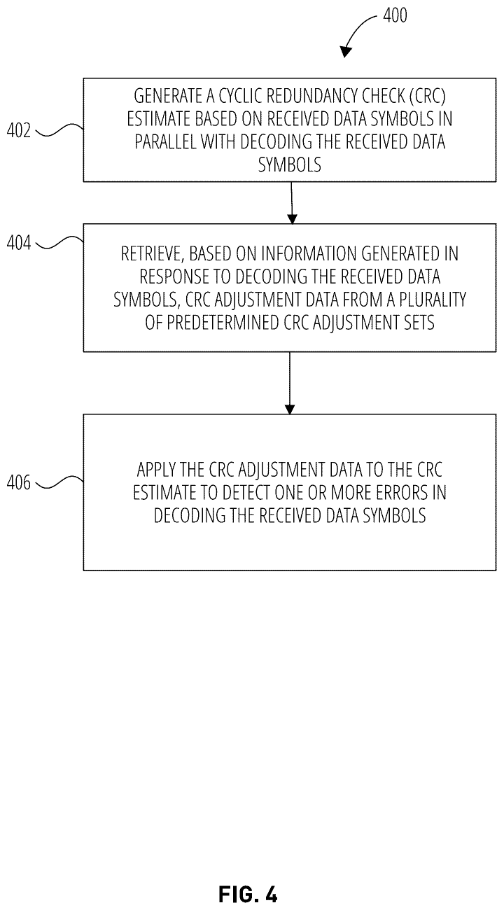

FIG. 4 illustrates a flow diagram 400 showing operations performed by the CRC component 113. The process can be implemented through various forms of processing logic, including hardware components (such as processing devices, dedicated logic circuits, programmable logic, microcode, or integrated circuits), software instructions executed on a processing device, or combinations thereof. The memory sub-system controller 115 or its subcomponents can perform these operations, with the CRC component 113 handling certain aspects of the process.

The flow diagram 400 begins at operation 402 where the CRC component generates a CRC estimate based on received data symbols in parallel with decoding the received data symbols, as discussed above. This parallel processing approach uses a state-space model that can handle 32 symbols per cycle to generate the CRC estimate while Reed-Solomon decoding is ongoing.

At operation 404, the CRC component 113 retrieves CRC adjustment data from predetermined CRC adjustment sets based on information generated during the decoding of the received data symbols, as discussed above. The predetermined adjustment sets can include lookup tables containing remainder values that correspond to different error locations and magnitudes identified by the Reed-Solomon decoder.

At operation 406, the CRC component 113 applies the retrieved CRC adjustment data to the CRC estimate to detect one or more errors in decoding the received data symbols. This involves performing exclusive-OR operations between the CRC estimate and the adjustment values obtained from the lookup tables based on the error locations and magnitudes provided by the RS decoder. The result of these operations indicates whether errors exist in the decoded data, allowing for early detection of decoding errors without waiting for complete decode processing.

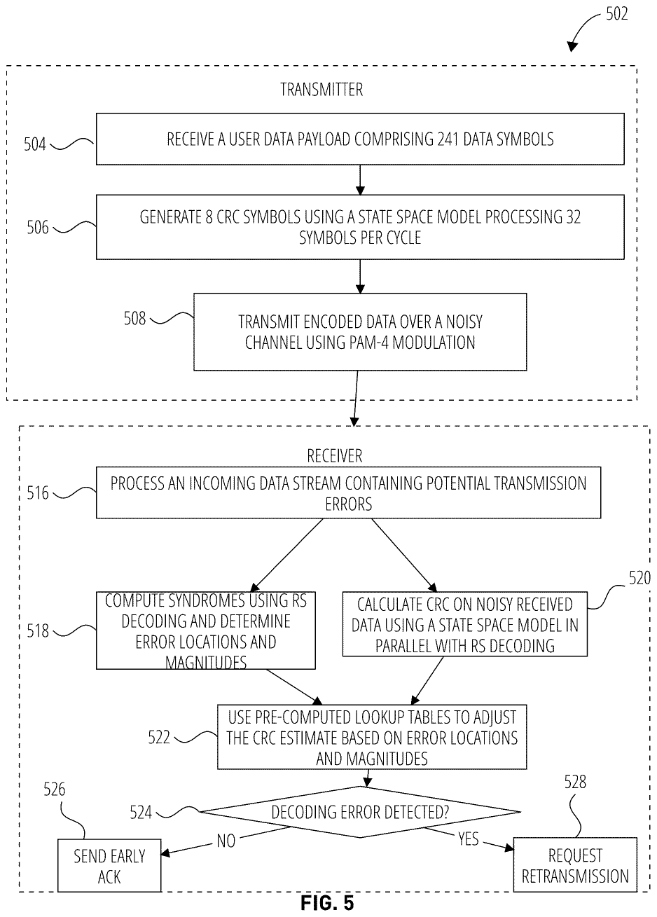

FIG. 5 illustrates a flow diagram 502 showing operations performed by the CRC component 113. The process can be implemented through various forms of processing logic, including hardware components (such as processing devices, dedicated logic circuits, programmable logic, microcode, or integrated circuits), software instructions executed on a processing device, or combinations thereof. The memory sub-system controller 115 or its subcomponents can perform these operations, with the CRC component 113 handling key aspects of the process.

The diagram 502 begins at operation 504 where the transmitter that includes a first instance of the CRC component 113 receives a user data payload that can include 241 data symbols. At operation 506, the CRC component 113 of the transmitter (e.g., the host system 120) generates 8 CRC symbols using a state space model that processes 32 symbols per cycle to enable efficient parallel computation.

At operation 508, the encoded data is transmitted over a noisy channel using PAM-4 modulation to a receiver (e.g., a second instance of the CRC component 113 implemented by the memory sub-system controller 115). The data then enters the receiver portion, where at operation 516, the CRC component 113 of the receiver processes an incoming data stream containing potential transmission errors. The received data is processed along two parallel paths: At operation 518, the CRC component 113 of the receiver computes syndromes using RS decoding to determine error locations and magnitudes. Simultaneously, at operation 520, the CRC component 113 of the receiver calculates an estimated CRC on the noisy received data using a state space model operating in parallel with the RS decoding.

At operation 522, the CRC component 113 of the receiver uses pre-computed lookup tables to adjust the CRC estimate based on the error locations and magnitudes identified by the RS decoder. These lookup tables enable quick CRC adjustments without requiring complete re-computation. At operation 524, the CRC component 113 of the receiver determines if any decoding errors are detected. Based on this determination, if no errors are detected (operation 526), the CRC component 113 of the receiver sends an early ACK signal to the transmitted. If errors are detected (operation 528), the CRC component 113 of the receiver requests retransmission of the data from the transmitter.

This parallel processing approach with early error detection enables reduced buffer requirements from 16 KB to as low as 8 KB or 10 KB, improving system throughput compared to traditional sequential CRC checking.

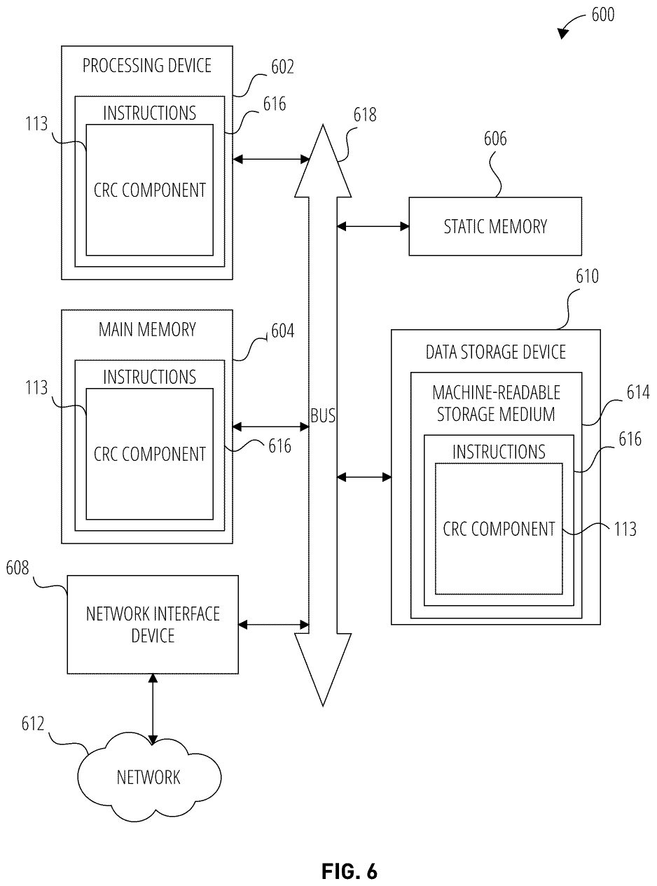

FIG. 6 illustrates an example machine in the form of a computer system 600 within which a set of instructions can be executed for causing the machine to perform any one or more of the methodologies discussed herein. In some examples, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage device 610, which communicate with each other via a bus 618.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application-specific integrated circuit (ASIC), a field programmable gate array (FPGA), a digital signal processor (DSP), a network processor, or the like. The processing device 602 is configured (or programmed) to execute instructions 616 for performing the operations and steps discussed herein. The computer system 600 can further include a network interface device 608 to communicate over a network 612.

The data storage device 610 can include a machine-readable storage medium 614 (also known as a computer-readable medium) on which is stored one or more sets of instructions 616 or software embodying any one or more of the methodologies or functions described herein. The instructions 616 can also reside, completely or at least partially, within the main memory 604 and/or within the processing device 602 during execution thereof by the computer system 600, the main memory 604 and the processing device 602 also constituting machine-readable storage media. The machine-readable storage medium 614, data storage device 610, and/or main memory 604 can correspond to the memory sub-system 110 of FIG. 1.

In one example, the instructions 616 include instructions to implement functionality corresponding to providing block failure protection for a zone memory sub-system as described herein (e.g., the CRC component 113 of FIG. 1). While the machine-readable storage medium 614 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1. A system comprising: a memory device; and a processing device, operatively coupled to the memory device, programmed to perform operations comprising: generating a cyclic redundancy check (CRC) estimate based on received data symbols in parallel with decoding the received data symbols; retrieving, based on information generated in response to decoding the received data symbols, CRC adjustment data from a plurality of predetermined CRC adjustment sets; applying the CRC adjustment data to the CRC estimate to detect one or more errors in decoding the received data symbols.

Example 2. The system of Example 1, the operations comprising: generating the CRC estimate using a state-space model that processes multiple data symbols in parallel to generate corresponding remainder values.

Example 3. The system of Example 2, wherein the state-space model processes at least 32 symbols per cycle.

Example 4. The system of any one of Examples 1-3, the operations comprising: processing the received data symbols using a Reed-Solomon decoder to decode the received data symbols while the CRC estimate is being generated using a state-space model.

Example 5. The system of Example 4, the Reed-Solomon decoder providing an error magnitude and error location in the received data symbols, the operations comprising: storing a plurality of matrices of remainder values as the plurality of predetermined CRC adjustment sets.

Example 6. The system of Example 5, wherein storing the plurality of matrices comprises: for each symbol position: generating an adjustment matrix comprising remainder values, each row of the adjustment matrix corresponds to an error magnitude represented as a power of 2, each remainder value is computed by evaluating R_{g(x)}[x⁸a(x)] where: g(x) is a generator polynomial of degree 8, a(x) represents a polynomial with a single nonzero value at the symbol position, and the remainder values are computed in a Galois Field GF(2⁸).

Example 7. The system of Example 6, wherein the remainder values, in the adjustment matrix, enable reconstruction of a CRC adjustment for any error magnitude between 0 and 255 by selecting and combining rows corresponding to a binary decomposition of the error magnitude.

Example 8. The system of any one of Examples 6-7, the operations comprising computing the remainder values of the adjustment matrix by: setting all polynomial coefficients to zero except at a symbol position being processed; evaluating the remainder using the generator polynomial, and storing resulting remainder coefficients as a row in the adjustment matrix.

Example 9. The system of any one of Examples 5-8, wherein the remainder values stored in the plurality of matrices correspond to different error magnitudes represented as powers of 2, and wherein each matrix of the plurality of matrices corresponds to a different error location.

Example 10. The system of any one of Examples 5-9, the operations comprising: selecting an individual matrix of the plurality of matrices corresponding to the error location provided by the Reed-Solomon decoder; and retrieving, as the CRC adjustment data, a set of rows of the individual matrix corresponding to a value of the error magnitude provided by the Reed-Solomon decoder.

Example 11. The system of Example 10, the operations comprising: performing an exclusive-OR logic operation on values of the retrieved set of rows to generate a partial CRC adjustment; performing an exclusive-OR operation between the partial CRC adjustment and corresponding symbol locations of the CRC estimate; and detecting that one or more errors exist in decoding the received data symbols in response to determining that a result of performing the exclusive-OR operation between the partial CRC adjustment and the corresponding symbol locations of the CRC estimate is non-zero.

Example 12. The system of any one of Examples 1-11, the operations comprising: receiving, as the received data symbols, data from a host system coupled to the processing device, the host system generating the data by encoding user data in accordance with a state-space model to generate the data symbols that include the CRC information.

Example 13. The system of any one of Examples 1-12, wherein generating the CRC estimate using a state-space model comprises: processing the received data symbols in accordance with: where r(t) represents a state vector, t represents a current state, w represents how many symbols are processed in parallel, A represents a predetermined matrix made up of a generator polynomial (g(x)) and an Identity matrix, u represents a message polynomial based on the received data symbols.

Example 14. The system of any one of Examples 1-14, the operations comprising: determining that the CRC estimate indicates no errors are present in the received data symbols; and in response to determining that the CRC estimate indicates no errors are present in the received data symbols, transmitting an acknowledgment signal to a device from which the received data symbols were received before completing decoding of the received data symbols.

Example 15. The system of any one of Examples 1-14, the operations comprising: determining whether to transmit an acknowledgment signal or negative acknowledgment signal based on the CRC estimate before processing all received data symbols in a buffer at a sender device.

Example 16. The system of Example 15, the operations comprising: processing received data symbols at a rate of 32 symbols per cycle, generating CRC estimates in parallel with syndrome computation, and transmitting acknowledgment signals based on the CRC estimates and adjustments before completing full decode processing.

Example 17. At least one non-transitory machine-readable storage medium comprising instructions that, when executed by a processing device, cause the processing device to perform operations comprising: generating a cyclic redundancy check (CRC) estimate based on received data symbols in parallel with decoding the received data symbols; retrieving, based on information generated in response to decoding the received data symbols, CRC adjustment data from a plurality of predetermined CRC adjustment sets; applying the CRC adjustment data to the CRC estimate to detect one or more errors in decoding the received data symbols.

Example 18. A method comprising: generating a cyclic redundancy check (CRC) estimate based on received data symbols in parallel with decoding the received data symbols; retrieving, based on information generated in response to decoding the received data symbols, CRC adjustment data from a plurality of predetermined CRC adjustment sets; applying the CRC adjustment data to the CRC estimate to detect one or more errors in decoding the received data symbols.

Example 19. The method of Example 18, comprising: generating the CRC estimate using a state-space model that processes multiple data symbols in parallel to generate corresponding remainder values.

Example 20. The method of Example 19, wherein the state-space model processes at least 32 symbols per cycle.

The term “coupled with” generally refers to a connection between components, which can be an indirect communicative connection or direct communicative connection (e.g., without intervening components), whether wired or wireless, including connections such as electrical, optical, magnetic, and the like.

“System data” hereinafter refers to data that is created and/or maintained by the memory sub-system for performing operations in response to host requests and for media management.

“User data” hereinafter generally refers to host data and garbage collection data.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader scope of examples of the disclosure as set forth in the following claims. The specification and drawings are, accordingly, to be regarded in an illustrative sense rather than a restrictive sense.

1. A system comprising:
a memory device; and
a processing device, operatively coupled to the memory device, programmed to perform operations comprising:
generating a cyclic redundancy check (CRC) estimate based on received data symbols in parallel with decoding the received data symbols;
retrieving, based on information generated in response to decoding the received data symbols, CRC adjustment data from a plurality of predetermined CRC adjustment sets; and
applying the CRC adjustment data to the CRC estimate to detect one or more errors in decoding the received data symbols.

2. The system of claim 1, the operations comprising:
generating the CRC estimate using a state-space model that processes multiple data symbols in parallel to generate corresponding remainder values.

3. The system of claim 2, wherein the state-space model processes at least 32 symbols per cycle.

4. The system of claim 1, the operations comprising:
processing the received data symbols using a Reed-Solomon decoder to decode the received data symbols while the CRC estimate is being generated using a state-space model.

5. The system of claim 4, the Reed-Solomon decoder providing an error magnitude and error location in the received data symbols, the operations comprising:
storing a plurality of matrices of remainder values as the plurality of predetermined CRC adjustment sets.

6. The system of claim 5, wherein storing the plurality of matrices comprises:
for each symbol position:
generating an adjustment matrix comprising remainder values, each row of the adjustment matrix corresponds to an error magnitude represented as a power of 2, each remainder value is computed by evaluating R_{g(x)}[x⁸a(x)] where:
g(x) is a generator polynomial of degree 8,
a(x) represents a polynomial with a single nonzero value at the symbol position, and
the remainder values are computed in a Galois Field GF(2⁸).

7. The system of claim 6, wherein the remainder values, in the adjustment matrix, enable reconstruction of a CRC adjustment for any error magnitude between 0 and 255 by selecting and combining rows corresponding to a binary decomposition of the error magnitude.

8. The system of claim 6, the operations comprising computing the remainder values of the adjustment matrix by:
setting all polynomial coefficients to zero except at a symbol position being processed;
evaluating the remainder using the generator polynomial, and
storing resulting remainder coefficients as a row in the adjustment matrix.

9. The system of claim 5, wherein the remainder values stored in the plurality of matrices correspond to different error magnitudes represented as powers of 2, and wherein each matrix of the plurality of matrices corresponds to a different error location.

10. The system of claim 5, the operations comprising:
selecting an individual matrix of the plurality of matrices corresponding to the error location provided by the Reed-Solomon decoder; and
retrieving, as the CRC adjustment data, a set of rows of the individual matrix corresponding to a value of the error magnitude provided by the Reed-Solomon decoder.

11. The system of claim 10, the operations comprising:
performing an exclusive-OR logic operation on values of the retrieved set of rows to generate a partial CRC adjustment;
performing an exclusive-OR operation between the partial CRC adjustment and corresponding symbol locations of the CRC estimate; and
detecting that one or more errors exist in decoding the received data symbols in response to determining that a result of performing the exclusive-OR operation between the partial CRC adjustment and the corresponding symbol locations of the CRC estimate is non-zero.

12. The system of claim 1, the operations comprising:
receiving, as the received data symbols, data from a host system coupled to the processing device, the host system generating the data by encoding user data in accordance with a state-space model to generate the data symbols that include the CRC information.

13. The system of claim 1, wherein generating the CRC estimate using a state-space model comprises:
processing the received data symbols in accordance with:
r(t+w)=A^{w}r(t)+A^{w-1}bu(t)+ . . . +Abu(t+w−2)+bu(t+w−1)
where r(t) represents a state vector, t represents a current state, w represents how many symbols are processed in parallel, A represents a predetermined matrix made up of a generator polynomial (g(x)) and an Identity matrix, u represents a message polynomial based on the received data symbols.

14. The system of claim 1, the operations comprising:
determining that the CRC estimate indicates no errors are present in the received data symbols; and
in response to determining that the CRC estimate indicates no errors are present in the received data symbols, transmitting an acknowledgment signal to a device from which the received data symbols were received before completing decoding of the received data symbols.

15. The system of claim 1, the operations comprising:
determining whether to transmit an acknowledgment signal or negative acknowledgment signal based on the CRC estimate before processing all received data symbols in a buffer at a sender device.

16. The system of claim 15, the operations comprising:
processing received data symbols at a rate of 32 symbols per cycle,
generating CRC estimates in parallel with syndrome computation, and
transmitting acknowledgment signals based on the CRC estimates and adjustments before completing full decode processing.

17. At least one non-transitory machine-readable storage medium comprising instructions that, when executed by a processing device, cause the processing device to perform operations comprising:
generating a cyclic redundancy check (CRC) estimate based on received data symbols in parallel with decoding the received data symbols;
retrieving, based on information generated in response to decoding the received data symbols, CRC adjustment data from a plurality of predetermined CRC adjustment sets; and
applying the CRC adjustment data to the CRC estimate to detect one or more errors in decoding the received data symbols.

18. A method comprising:
generating a cyclic redundancy check (CRC) estimate based on received data symbols in parallel with decoding the received data symbols;
retrieving, based on information generated in response to decoding the received data symbols, CRC adjustment data from a plurality of predetermined CRC adjustment sets; and
applying the CRC adjustment data to the CRC estimate to detect one or more errors in decoding the received data symbols.

19. The method of claim 18, comprising:
generating the CRC estimate using a state-space model that processes multiple data symbols in parallel to generate corresponding remainder values.

20. The method of claim 19, wherein the state-space model processes at least 32 symbols per cycle.
